(19) United States
(12) Patent Application Publication
(10) Pub. No.: US 2002/0085164 A1
(43) Pub. Date: Jul. 4, 2002

(54) Display medium

(76) Inventor: Andrew James Stanford-Clark, Chale (GB)

Correspondence Address: IBM CORPORATION, T.J. WATSON RESEARCH CENTER, P.O. BOX 218, YORKTOWN HEIGHTS, NY, 10598, US

(21) Appl. No.: 09/683,342

(22) Filed: Dec. 17, 2001

(30) Foreign Application Priority Data
Dec. 21, 2000 (GB) 0031189.4

(51) Int. Cl. C09K 19/02

(52) U.S. Cl. 349/167

(57) ABSTRACT

A display medium having temperature sensitive regions that are adapted to display a first image within a first temperature range and a second image within a second temperature range. The images are barcodes and provide information about the product to which they are attached. For example, the first image may provide information about a product in a chilled state, while the second image may provide information about the same product in the frozen state.

### BACKGROUND OF THE INVENTION

1. Field of Invention

The present invention relates to the retail industry, and more particularly to the identification of products within that industry and the information associated therewith.

### Background of the Invention

Just about every saleable item now has a Universal Product Code (UPC) barcode attached to, or printed on it. These were originally used as a means of increasing checkout throughput and keeping track of stock levels in grocery stores. Their enormous success, however, has meant that they are now found on virtually all retail products. FIG. 1 shows an example barcode 10. Please note, this is in no way intended to be an accurate representation, but rather to convey the general idea. It can be seen that a barcode is typically composed of a number of black strips 20, interposed by white strips 30. For each white strip a binary digit 0 is read, while each black strip equates to a binary digit 1. The opposite can also be true. Note, apparent thickness of some strips in the figure equates to a number of fixed width strips.

The sequence of binary digits so created by such a barcode permit a laser scanner (not shown) to correlate goods to codes. The dark strips absorb light emitted by such a scanner, while the white strips reflect the light, thereby allowing the scanner to distinguish between the two types of strip.

The number read by the scanner is typically transmitted to a central point of sale (POS) and provides an index into a database at that location. Such a database may contain a variety of information. Examples include price, discounts, stock level, ingredients etc. For a fuller explanation of the intricacies of barcodes, please see the following web sites:

“www.beakman.bonus.com/beakman/upc/barcode.html”; and

“www.howstuffworks.com/upc.htm”

The electronics industry has developed a number of ways of using the information that a barcode can provide, beyond simply the shop checkout. For example, the International Housewares Show held in Chicago in January 1999 showcased the first intelligent microwave, which has been developed by researchers at Cook College/Rutgers University in conjunction with Samsung Electronics America, Inc. Such a microwave has an integrated barcode scanner and uses information referenced by a foodstuff's barcode to determine the appropriate cooking time, temperature, caloric content and ingredients. The latter is useful if, for example, the user is allergic to a particular ingredient. An overview of the developments in the field of intelligent machines can be found at the following web site:

“www.smartcomputing.com/editorial/article.asp?article=articles%2Farchive%2Fg0806% 2F18g06%2F18g06%2Easp”.

It will thus be appreciated that barcodes are used for a variety of different tasks, from checking out goods at the supermarket and keeping tally of stock levels to automatically cooking food in the microwave. While two items may be essentially the same, the temperature of those items may require that different information be attributed to them. With the intelligent microwave example, it is no good scanning a foodstuff's barcode to automatically program the microwave with an appropriate cooking time, if that cooking time relates to a chilled item, which a consumer has subsequently frozen. It will be appreciated that the foodstuff will require longer in the microwave.

To provide another example, when checking perishable goods in at a supermarket, the barcode of each item is typically automatically scanned by a laser barcode reader and that item added to the stock inventory. A problem arises if, for example, a frozen item has been allowed to defrost, or a chilled item has been heated (by the sun or otherwise) above the desire temperature, such that is no longer safe for consumption.

To build on the previous example, it is possible that goods may have been left out of a freezer (unintentionally or otherwise), but frozen before reaching the supermarket such that the fact that the product has been allowed to thaw is hidden.

U.S. Pat. No. 5,298,476 discloses a rewriteable barcode display medium, which varies in transparency with a change in temperature such that a barcode may be erased by being passed through a heat-application roller and a new barcode formed by the application of heat from a thermal head. This patent does not solve the issue of having a display medium, which is adapted to form two different images within different temperature ranges.

Also known is the use of sterile dressings in medipacs that show a cross (X) at a certain temperature such that it is obvious to a user that they have been properly sterilized. While an image is formed over a certain temperature range, the image alone cannot be used to identify different products. Further only one image is displayed, not two images within two different temperature ranges. Further still, it is not intended to be automatically scanned, but is a visible warning to the user of that dressing.

Still further known are novelty mugs, which have a first picture (image) on the front, which then changes to a second picture when hot water is poured into the mug. The images cannot be used to identify different products and are not intended to be automatically scanned. They provide no information about the product.

It has already been seen that intelligent microwaves, for example, use barcode information to determine the appropriate cooking time, heat setting etc. for a foodstuff. However, such parameters can vary dependent upon the state of the foodstuff being cooked. In the past the information provided by a barcode has merely been a product identifier, which does not take account of the state in which the food was sold or whether a chilled item was subsequently frozen by the consumer. Therefore, the barcode did not provide sufficient information to enable determination of an appropriate cooking time etc.

### SUMMARY OF INVENTION

According to a preferred embodiment of the present invention, a display medium includes at least two temperature sensitive zones, a first zone being adapted to display the first image, and a second zone being adapted to display the second image. The images provide information about a product to which the display mediums are attached.

According to another aspect of the present invention, a display medium includes at least one image and at least one identifier. The at least one identifier is formed in a temperature sensitive material adapted to display the identifier over a first temperature range.

According to yet a further aspect of the present invention, an image reader includes an intergrated reader unit for reading at least one image providing a first information about a particular product to which said at least one image is attached, wherein said at least one image is associated with at least one identifier formed in a temperature sensitive material, wherein said identifier is adapted to be displayed over a first temperature range, said at least one identifier providing a second information about said product; said reader unit is used for reading said identifier when displayed; a reference unit for referencing said first information or said first and said second information dependent upon whether said at least one image or said at least one image and said at least one identifier is read by the reader unit; and a decision device for taking an appropriate action.

According to yet a still further aspect of the present invention, a method for creating a display medium includes the steps of: providing at least two temperature sensitive zones within the display medium, a first zone being adapted to display a first image within a first temperature range, and a second zone being adapted to display a second image within a second temperature range. Each image provides information about a product to which the display medium is attached.

According to another aspect of the present invention, a method for creating a display medium includes the steps of: providing at least one image; and forming at least one identifier in a temperature sensitive material, the at least one identifier being adapted to be displayed over a first temperature range.

According to still yet another aspect of the present invention, a system comprising an integrated image reader for reading one of at least two images attached to a product and formed in a temperature sensitive material, a first image adapted to be displayed over a first temperature range, and a second image adapted to be displayed over a second temperature range. The system includes a reading unit for reading a displayed image, a storage device for storing a first information relating to the first image. The storage device further stores the second information relating to the second image. An access unit is provided for accessing the first information or the second information dependent upon whether the first or the second image is read by the integrated image reader. Further included is an action taking unit for taking an appropriate action based on the information accessed.

According to still another aspect of the present invention, a system includes an integrated image reader for reading at least one image attached to a product, wherein the at least one image is associated with at least one identifier, and the at least one identifier being formed in a temperature sensitive material adapted to display the at least one identifier over a first temperature range. The system uses the reader for reading the at least one image and for reading the at least one identifier when displayed. A storage device is used for storing a first information relating to the at least one image. A storage device is used for storing a second information relating to the at least one identifier. The system further includes an access unit for accessing one of the first information or the first information and the second information dependent upon whether the at least one image or the at least one image and the at least one identifier is read by integrated image reader, an action taking unit for taking an appropriate action based on said information accessed.

Various other objects, features, and attendant advantages of the present invention will become more fully appreciated as the same becomes better understood when considered in conjunction with the accompanying drawings, in which like reference characters designate the same or similar parts throughout the several views.

### BRIEF DESCRIPTION OF DRAWINGS

A preferred embodiment of the present invention will now be described, by way of example only, and with reference to the following drawings.

FIG. 1 is of an example barcode according to the prior art.

FIG. 2 illustrates the typical composition of solids, liquids or gases.

FIG. 3 illustrates the typical composition of a liquid crystal material.

FIG. 4 illustrates the chiral nematic crystalline phase.

FIG. 5 is of the visible region of the Electromagnetic Spectrum.

FIG. 6 shows a wave of light.

FIG. 7 shows two adjacent barcodes according to a preferred embodiment of the present invention.

FIG. 8 shows two barcodes placed on top of one another according to an alternative embodiment of the present invention.

FIG. 9a is a component diagram of one example use of the present invention.

FIG. 9b is a flowchart illustrating the operation of an intelligent microwave according to a preferred embodiment of the present invention.

FIGS. 10a, 10b and 10c show an alternative example use of the present invention.

### DETAILED DESCRIPTION

Accordingly, the invention provides a temperature sensitive display medium which is adapted to display a first image within a first temperature range and a second image within a second temperature range, wherein each image provides information about a product to which the display medium is attached.

Now according to the preferred embodiment, information relating to the chilled product can, for example, be provided via the first image and information relating to the frozen product can be provided via the second image.

Preferably the temperature sensitive material is of a liquid crystal composition. A first blend of liquid crystals form the first image, while a second blend of liquid crystals form the second image. According to the preferred embodiment, the first blend reflects a colored light over the first temperature range, such that the first image is displayed over the first temperature range. Preferably, the second blend reflects a colored light over the second temperature range such that the second image is displayed over the second temperature range.

Typically such barcodes are read by a laser scanner or barcode reader emitting red light. Thus it is preferable that the chosen blend of liquid crystals reflect red light over the desired temperature range. It should be noted that the invention is not limited to barcodes capable of being read by a laser scanner. For example, a light emitting diode (LED) may equally be utilized. Likewise, the invention is not limited to a barcode reader emitting red light, although this is currently most common.

According to a preferred embodiment a colored, light absorbent background material is used on which to display the two images. Preferably a part of the background material also forms part of the two images. Note, the invention is not limited to just two images.

Although the preferred embodiment has been described in terms of a temperature sensitive material of a liquid crystal composition, the invention is not limited to such. alternatives include: a thermochromic ink; a polymer; a liquid crystal polymer;

and a thermochromic dye.

According to one embodiment, the image display process is not a reversible process. In other words, once a transition from the first image to the second image has occurred, the first image is no longer displayable. Thus if, for example, the second barcode image is used to sound a warning that the product to which it is attached has been allowed to thaw, either unintentionally or otherwise, there is no way of hiding this (i.e. by re-freezing the product such that the first image is displayed again.)

According to one embodiment, the two temperature sensitive zones are formed adjacent to one another, with a transparent material covering them. This provides a robust structure. However since barcodes are not intended to have a long-life, the transparent material may be omitted. This configuration uses less space.

According to another embodiment, the second zone is formed on top of the first zone and the two zones are separated by a transparent material. In this instance, a transparent material covers the second zone, although once again this may be omitted for the reasons described above.

According to one embodiment, the image provides a first information regarding a product to which it is attached, and the at least one identifier provides a second information regarding the product to which it is attached.

Preferably, the display medium also comprises a second identifier also formed in a temperature sensitive material. The second identifier is visible over a second temperature range and provides a third information regarding the product to which it is attached.

According to a preferred embodiment, the first and second identifiers are simple shapes (for example a square and a triangle, respectively). Preferably the image comprises a barcode and by associating first and second identifiers with the barcode, it is not necessary to have more than one code for the different states of the same product.

By way of example, a system could include a cooking apparatus (such as an intelligent microwave of the kind described above, or an oven) and the appropriate action, mentioned above, comprises programming the cooking apparatus with stored parameters. Example parameters are a cooking time and a heat setting. Thus, it does not matter that a consumer has changed the state of a product from that in which it was bought (by, for example, chilling or freezing the product). It should be noted that the state of a product is not limited to chilled and frozen, but these are provided by way of example only.

Another example use relates to checking goods into a supermarket before placing them on the shelves for purchase by the consumer. Typically such goods are automatically scanned by a laser barcode reader and a stock level updated appropriately. Thus far there has been no way of automatically alerting supermarket personnel to the presence of a damaged item (for example, one which has been allowed to thaw, either unintentionally or otherwise.)

In this example, the first and second information preferably relates to the stock level of the product to which the at least two images are attached. One of the images keeps track of the damaged items. An alarm is, according to one embodiment, sounded when a damaged item is checked in.

Yet another example use is for checking that goods being placed in a refrigeration apparatus (e.g. fridge) are intended to be placed therein. For example an item may be too hot and a warning alarm sounded to warn of this when the item's displayed barcode is scanned.

Yet still another example use is for putting goods into a freezing apparatus (e.g. freezer). When a chilled product is placed in the freezer, the displayed barcode attached to it is scanned and it is determined that the temperature within at least a part of the freezing apparatus should be lowered (e.g. set to fast-freeze) for a predetermined amount of time, in order to more quickly freeze the product.

According to one embodiment a second identifier is also associated with the at least one image. This becomes visible over a second temperature range. A third information is stored relating to the second identifier and this is accessed when the first image and the second identifier are both read.

According to a preferred embodiment, a temperature sensitive material is used to form a first and second barcode image such that the first barcode is visible to a laser scanner over a first temperature range, while a second barcode is visible over a second temperature range.

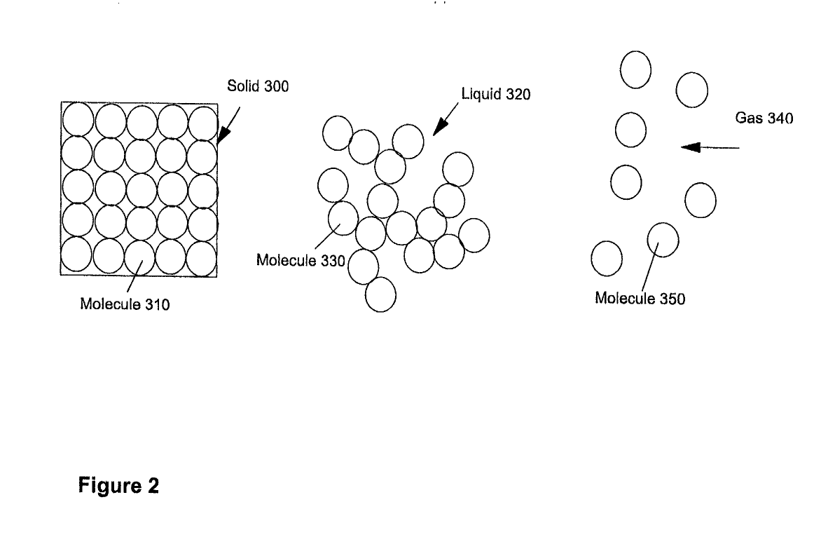

It is well known that materials exhibit different properties according to their temperature. At the simplest level, materials exist as one of three states: solids; liquids; and gases. This is illustrated by FIG. 2. A Solid 300 consists of regularly shaped molecules 310 arranged in a fixed and orderly pattern. Such molecules do not move, they vibrate about a fixed point. The molecules 330 in a liquid 320 move freely but always remain in close proximity with one another. In a gas 340 the molecules 350 move rapidly and randomly about. They do not remain in contact with one another.

As previously mentioned, a change in temperature causes the behavior of a material to change. For example, as a solid is heated, the molecules begin to vibrate with increased ferocity until at a predetermined threshold they are no longer fixed in position but can flow freely in the liquid state. As the liquid is heated the molecules actually break away from one another and the liquid evaporates to form a gas.

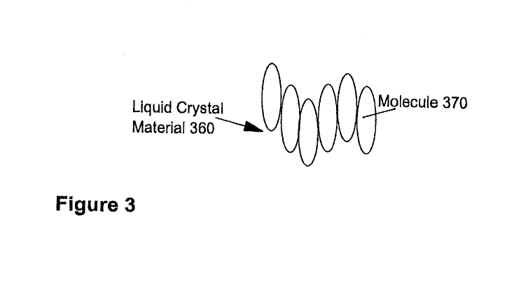

Within the boundaries defined by these three states, variations can occur. For example, a liquid crystal material 360 (shown in FIG. 3) comprises rod shaped molecules 370. As with the liquid state defined above, these molecules flow freely but always remain in contact with one another. Liquid crystals are commonly used in display devices (LCDs) (for example in calculators, clocks etc.). They provide compact displays and have a low power consumption.

Liquid crystals may be classified into one of two groups: thermotropic; and lyotropic. In the latter, behavior is influenced by both temperature and solvent concentration (these are found in shampoo for example). The behavior of thermotropic liquid crystals is influenced by temperature alone.

Thermotropic liquid crystals may be smetic or nematic. The molecules in the former are arranged in layers. Those in nematic liquid crystals do not have a layered structure but are typically in parallel to one another. Nematic liquid crystals are much more fluid than their smetic counterparts and therefore tend to be the ones used in LCDs etc.

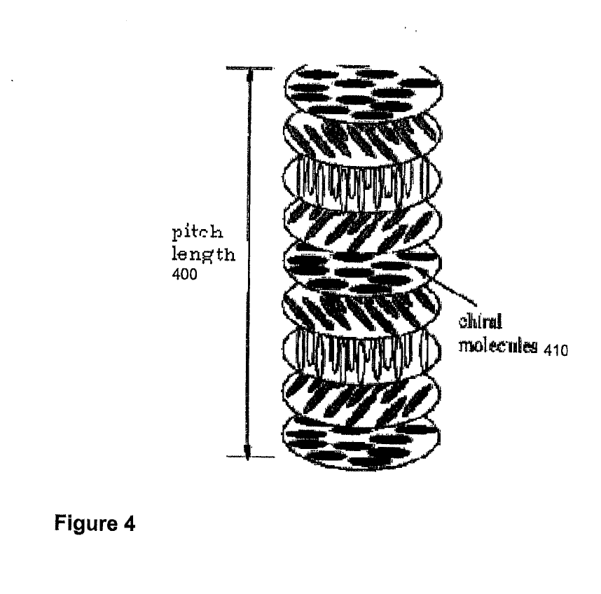

Not all materials are symmetrical. Such materials contain chiral or handed molecules. Chiral nematic liquid crystals, otherwise known as cholesteric liquid crystals, comprise molecules arranged in a helical or spiral pattern. FIG. 4 (available from the University of Hull's website, URL “www.hull.ac.uk/php/chpsmt/lc/history.html”) illustrates the chiral nematic crystalline phase. It can be seen that the chiral molecules 410 form a helical pattern. Such liquid crystals exhibit an extremely advantageous property. They can reflect light such that if the pitch 400 of the helical structure is equal to the wavelength of a colored light, the crystals will reflect that color.

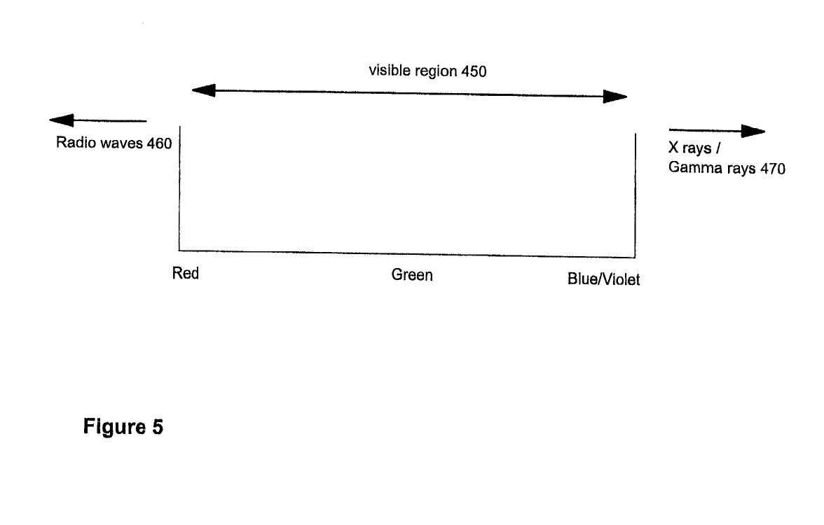

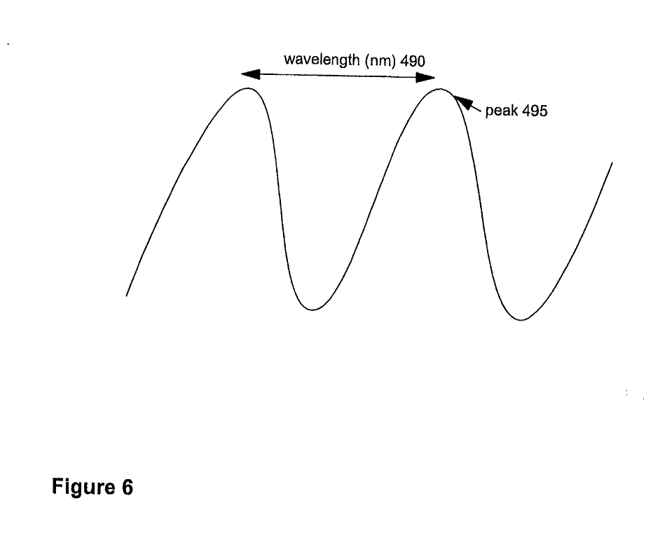

FIG. 5 illustrates the portion of the Electromagnetic spectrum known as the visible region 450. At the extreme left of this region the waves have the greatest length and reflect red light. In the middle green light is reflected and at the far right blue/violet light is reflected. The waves become shorter as one moves from left to right. To the left of the region are radio waves 460 and to the right are X/Gamma rays 470. FIG. 6 illustrates a wave. It can be seen that wavelength 490 is defined as the length between two successive peaks 495 of a wave.

Wavelength is measured in nanometres (nm) and the length of those reflecting red light is between 630 and 770 nm. At the other end of the visible region, violet light has a wave length of between 410 and 440 nm. More information on colored light can be found at “www.newi.ac.uk/buckleyc/light.htm”.

Returning to chiral nematic liquid crystals, as these liquid crystals are heated, the pitch length of the helix becomes shorter and hence the light eventually reflected is blue. As the crystals are cooled, the pitch increases and thus the crystals reflect light at the other end of the visible region (i.e. red light). Accordingly such liquid crystals are typically used to form a material strip for use as a thermometer in for example a fish tank. Appropriate liquid crystals are chosen such that they reflect a different colored light as each temperature threshold is crossed.

According to the preferred embodiment, the barcode is formed in a temperature sensitive material composed of chiral nematic liquid crystals. The University of Hull's website referenced above provides a useful source of information regarding liquid crystals.

According to one embodiment, the liquid crystals are sandwiched between a bottom black material and a top transparent material (e.g. perspex) in a layered structure. The liquid crystals are placed on the black material such that they form an appropriate pattern of strips in accordance with the item to which they correlate (i.e. the barcode formed references the appropriate item).

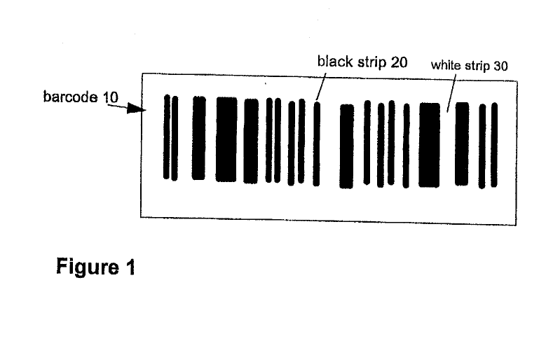

Laser scanners typically emit red light. Therefore, according to the preferred embodiment, chiral nematic liquid crystals which reflect red light over the desired temperature range are used. To refer back to the barcode example in the background section (FIG. 1), the liquid crystal strips equate to the white strips 30, and any spaces between these strips are black 20 due to the background material. Thus it can be seen that the invention is not limited to barcodes composed of black and white strips. Rather, it is preferable that a barcode is composed of portions which reflect light and portions which absorb light.

The appropriate barcode can therefore be read by the scanner (not shown). Different liquid crystal mixes (or blends) are already commercially available which reflect different colored light at different temperature ranges.

According to the preferred embodiment, a liquid crystal blend is used such that the colored (preferably red) strips of a first barcode are visible over a first temperature range (for example, 2 C to 4 C) and differently patterned strips of a second barcode are visible over a second temperature range (for example, below freezing).

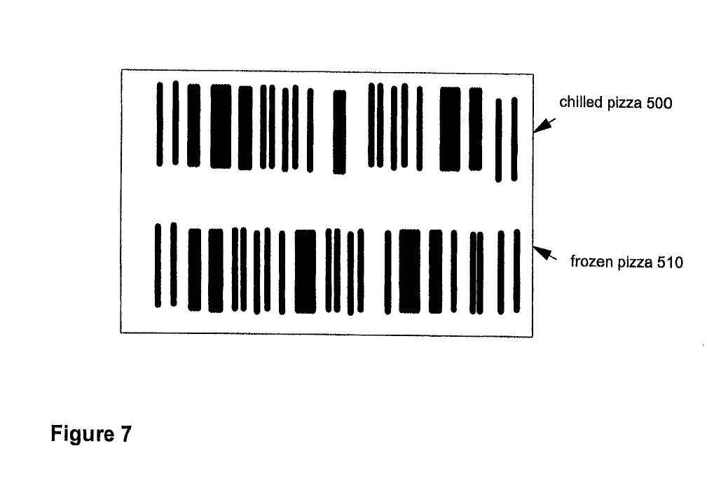

According to the preferred embodiment, the first barcode pattern is formed adjacent to the second barcode pattern. Whether the first or the second barcode is displayed depends upon the temperature of the item to which the barcode is adhered. (Note the barcode is preferably mounted such that it can accurately reflect the temperature of the product to which it is attached.) FIG. 7 shows two example adjacent barcodes. The first relates to chilled pizza 500, while the second is for the same pizza frozen 510. If, for instance, the preferred temperature range for a chilled pizza is between 2 C and 4 C, then the liquid crystals chosen for the chilled pizza barcode are such that the pitch of the liquid crystal material's helical structure is equal to the wavelength of red light (i.e. such that the crystal's reflect red light) over this temperature range. Regarding the frozen pizza: if, for instance, the preferred temperature range is between −2 C and −15 C, then the liquid crystals chosen for the second barcode are such that the pitch of the crystals' helical structure is equal to the wavelength of red light over this lower temperature range.

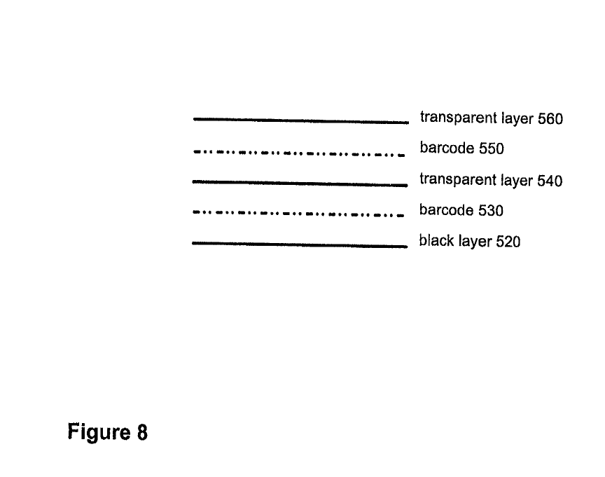

According to an alternative embodiment, the barcodes are placed on top of one another to save space. This can be achieved by placing a transparent layer (e.g. perspex) between the liquid crystals denoting the first barcode and the liquid crystals denoting the second barcode. This is shown in FIG. 8. Thus it does not matter that the two barcodes may overlap one another since barcode 530 is separated from barcode 550 by transparent layer 540.

It will be appreciated that the invention is not limited to barcodes formed from the kind of layered liquid crystal structure described above. It is just as applicable to thermochromic inks of the kind applied to cards and clothing. These are low cost, but also have a relatively low life expectancy. This is however perfectly adequate for use in forming a barcode image, since barcodes are expected to have a short life. Another alternative is to use a thermochromic polymer which is more robust. It will therefore be apparent that no limitation is intended, but rather that the invention is applicable to any temperature sensitive material.

It will be further appreciated that the present invention is not limited to red light laser barcode scanners. By way of alternative examples, other colored laser scanners may be employed or light emitting diodes (LEDs) etc..

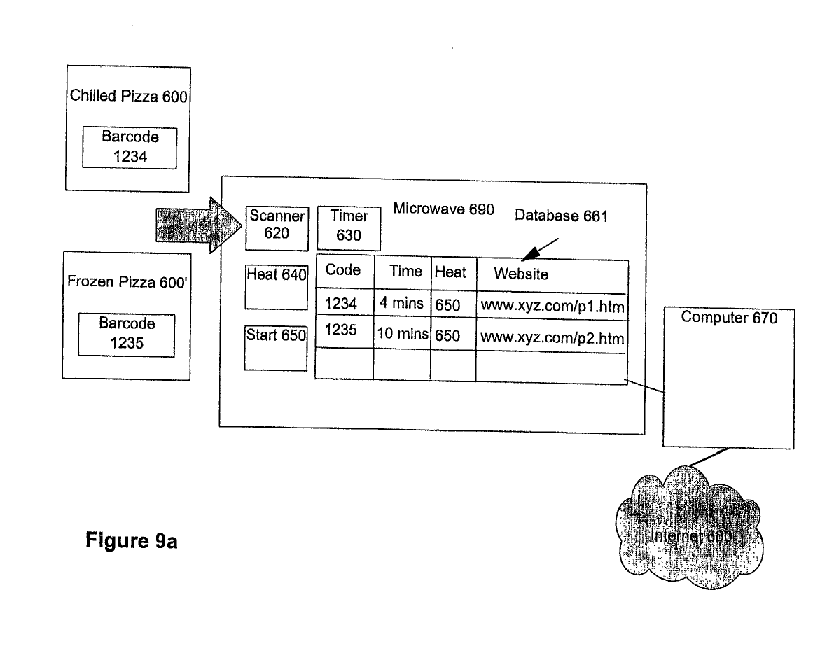

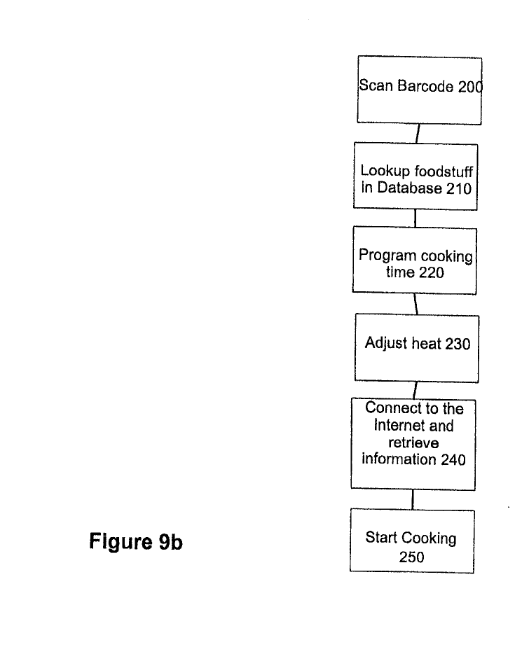

FIG. 9a is a component diagram of one example use of the present invention. A microwave 690 includes a barcode scanner 620, timer 630, heat adjustment control 640 and start button 650. It also has a database 661, with each record in the database including the following fields: code; time; heat; and website. (These will be explained below.) The microwave 690 is connected to a computer 670 which provides access to the Internet 680. In an alternative embodiment, the microwave is connected directly to the internet.

Chilled pizza 600 has a barcode 1234 adhered to its packaging (not shown), while the same pizza frozen 600′ has a barcode 1235. Note, although identified herein as a number, the barcode in reality is composed of a number of colored strips as shown in FIG. 1. In other words, the barcodes are formed in the kind of temperature sensitive material described above and the code changes as the temperature of the foodstuff changes. The database 661, holds the cooking details for both versions of the pizza. The chilled pizza cooks for 4 minutes (mins), while the frozen pizza cooks for 10 minutes. In this example the website addresses accessed for additional information are slightly different, however these could be the same.

FIG. 9b is a flowchart illustrating the operation of the intelligent microwave according to a preferred embodiment of the present invention. It should be read in conjunction with FIG. 9a. The barcode 1234/1235 is passed over the microwave's integrated scanner 620 at step 200. The number that the scanner reads (1234/1235) is used to look up the item (foodstuff) in database 661 at step 210. The time field is used to retrieve the appropriate cooking time for foodstuff 600/600′ and this is programmed using timer 630 at step 220. The heat field is used to adjust the heat control 640 to the optimum setting at step 230. Sometimes there will be additional information to retrieve and this is achieved by connecting, via the Internet, to either the manufacturer's or a third party's website at step 240. Such a website may provide the ingredients of a particular foodstuff and warn the user about any items they have specified that they are allergic to; it may download recipes including the scanned foodstuff 100 etc. The user may then be queried regarding the retrieved information (not shown) and once the microwave's controls have all been adjusted appropriately, the start button 650 is pressed and the cooking commenced at step 250. Note, the steps in the figure do not necessarily occur in the order shown, or for that matter have to occur at all. For example, the microwave may not have an Internet connection and therefore uses the information contained in database 661 only. Assuming that there is an Internet connection, then the database may store minimal information only (e.g. the manufacturer's website address) and use the Internet to retrieve the rest. Alternatively it may be the barcode itself which stores the necessary information for programming the microwave. For example, the barcode may store the website address for accessing the Internet and retrieving the additional information to program the microwave or the barcode may store more information of the kind mentioned above (e.g. cooking time etc.). Many variations are possible.

It should be noted that partially defrosted food could also be catered for by, for example, having three barcodes, one forming over each of three temperature ranges. Thus as the foodstuff nears room temperature, a barcode is formed which indicates a cooking time in between that for the chilled foodstuff and that for the frozen foodstuff.

It can thus be seen that the present invention is not limited to two working states (i.e. two barcodes) but may consist of many barcodes, with a different barcode becoming visible over a different temperature range.

It should also be appreciated that the invention is just as applicable to other kinds of cooking apparatus (for example, an oven with an integrated barcode scanner).

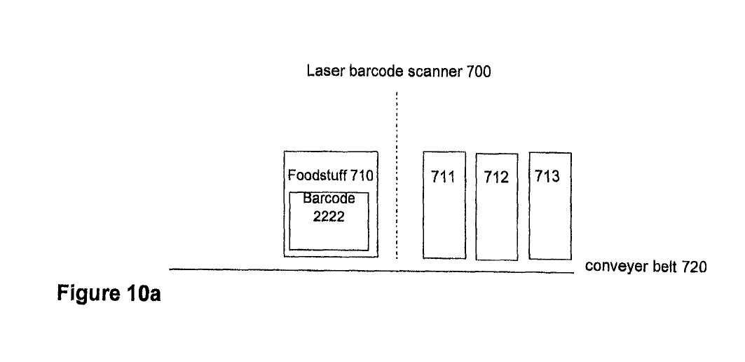

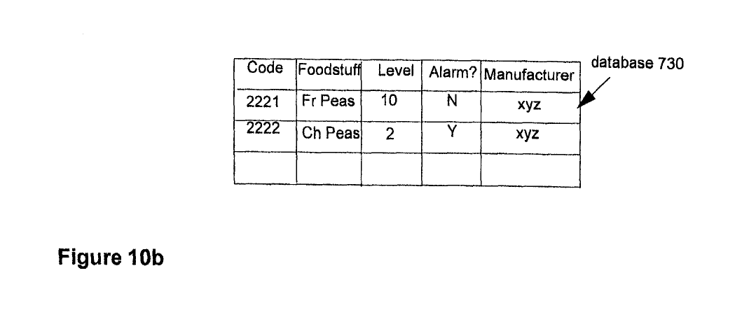

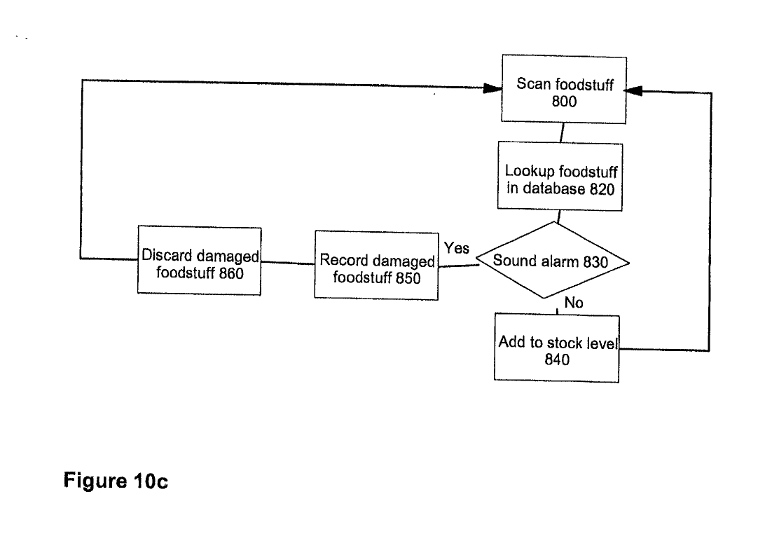

An alternative example use of the present invention will now be described with reference to FIGS. 10a, 10b and 10c. FIG. 10a shows foodstuffs 710, 711, 712 and 713 traveling on conveyer belt 720. Barcode 2222 is shown adhered to foodstuff 710 which has passed though the laser beam of barcode scanner 700. The other foodstuffs on conveyer belt 720 also have barcodes attached to them, but these are not shown. The foodstuffs, in this example, are being checked in at a supermarket before going onto the shelves for purchase by consumers.

FIG. 10b shows a database 730, with each record in the database including five fields: code (i.e. barcode); foodstuff (fr=frozen, ch=chilled); level (i.e. stock level); alarm; and manufacturer. Note these are exemplary only.

FIG. 10c is a flowchart of an exemplary operation of FIGS. 10a and 10b. Foodstuff 710 is scanned by laser barcode scanner 700 at step 800. The foodstuff is then looked up in database 730 at step 820. In this instance, barcode 2222 refers to chilled peas. This entry in database 730 indicates that the alarm should be sounded at step 830. This is because this make of peas (indicated by the manufacturer field in database 730) should be frozen only. If the alarm is sounded, then the damaged item is recorded in the database at step 850 (in the example, the number of chilled pea packages is two), and the damaged foodstuff is discarded at step 860. If the alarm is not sounded then the foodstuff is added to the stock level at step 840. Note, in this example damaged and non-damaged foodstuffs are recorded in the stock level field. The difference is however apparent from the flag in the Alarm field (i.e. if the alarm flag is set (Y) then the stock level reflects damaged foodstuffs).

To build upon this example and address a problem identified by the background section, it is possible that goods may have been left out of a freezer (either unintentionally or otherwise), but frozen before reaching the supermarket such that it is not obvious that they have been allowed to thaw. According to one embodiment, the barcode is formed in a temperature sensitive material and once formed, the change is irreversible. Therefore, once the temperature change is significant enough to cause the second barcode to be formed (i.e. by allowing a product to thaw), the original barcode cannot be re-formed (by re-freezing the product). Thus there it is more difficult to hide that the product has been allowed to thaw. In this example, the barcodes are preferably formed using thermochromic dyes which are visible over the appropriate temperature range. By way of example, the product to which the barcodes relate is meant to be frozen. Dye1 shows below freezing and Dye2 shows at room temperature. (Note, a combination of dyes may be used for each barcode to achieve the desired result.) It will be appreciated that part of the barcodes will have to be printed and then later activated when at the right temperature. Otherwise, the one way trigger may occur too early (i.e. at the time of printing). Activation may be chemical, by ultraviolet light, or otherwise. In one embodiment, the barcodes are formed of a smetic liquid crystal material and printed using an electrostatic print head. Once again, once a barcode has formed, the change is irreversible.

It will be appreciated that the present invention is applicable to many other scenarios and that the uses described with reference to FIGS. 9, 10a, 10b and 10c are example uses only.

In an alternative embodiment, the same barcode is used over both temperature ranges (i.e. the barcode itself does not have to be formed out of a temperature sensitive material). However, a first identifier is associated with the barcode over a first temperature range and a second identifier is associated with the barcode over a second temperature range (i.e. the identifiers are formed out of a temperature sensitive material). This could be a simple shape (for example, a square to indicate frozen and a triangle to indicate chilled). The barcode scanner is thus modified to take account of this. Alternatively, one shape is used. A barcode with no shape visible means that the product is frozen, the shape references the chilled version. Of course, the opposite could be true. Further the invention is not limited to two identifiers only. This method means that a different barcode is not required for the chilled and frozen version of the same product.

It will be appreciated that while the present application has been described in the context of barcodes, the invention is not limited to such. It is applicable to any form of identification (image) that can be used to distinguish one product from another. According to the preferred embodiment, the image consists of liquid crystal strips on a black background. The liquid crystal strips are so spaced that black strips (from the black background) are interposed between the liquid crystal strips.

It is to be understood that the provided illustrative examples are by no means exhaustive of the many possible uses for my invention.

From the foregoing description, one skilled in the art can easily ascertain the essential characteristics of this invention and, without departing from the spirit and scope thereof, can make various changes and modifications of the invention to adapt it to various usages and conditions.

It is to be understood that the present invention is not limited to the embodiments described above, but encompasses any and all embodiments within the scope of the following claims:

1. A temperature sensitive display medium which is adapted to display a first image within a first temperature range and a second image within a second temperature range, wherein each image provides information about a product to which the display medium is attached.

2. The display medium of claim 1, further comprising at least two temperature sensitive zones, a first zone being adapted to display said first image, and a second zone being adapted to display said second image.

3. The display medium of claim 1, wherein said first and second images comprise barcodes.

4. The display medium of claim 1, wherein the temperature sensitive material comprises liquid crystals.

5. The display medium of claim 4, wherein a first blend of liquid crystals form said first image.

6. The display medium of claim 5, wherein said first blend reflects a colored light over said first temperature range, such that said first image is displayed over said first temperature range.

7. The display medium of claim 4, wherein a second blend of liquid crystals form said second image.

8. The display medium of claim 7, wherein said second blend reflects a colored light over said second temperature range such that said second image is displayed over said second temperature range.

9. The display medium of claim 1 further comprising:
a colored, light absorbent background material, said first and second images being displayed on said background material and wherein a part of said background material forms part of said first and second images.

10. The display medium of claim 1, wherein the temperature sensitive material comprises a thermochromic ink.

11. The display medium of claim 1, wherein the temperature sensitive material comprises one of a polymer and a liquid crystal polymer.

12. The display medium of claim 1, wherein the temperature sensitive material comprises a thermochromic dye.

13. The display medium of claim 12, wherein said image display process is not a reversible process.

14. The display medium of claim 2, wherein said first and second zones are adjacent to one another.

15. The display medium of claim 14, further comprising a transparent material covering said first and second zones.

16. The display medium of claim 2, wherein said second zone is on top of said first zone, said first and second zones being separated by a transparent material.

17. The display medium of claim 16, further comprising a transparent material covering said second image.

18. A display medium comprising:
at least one image; and
at least one identifier, wherein said at least one identifier is formed in a temperature sensitive material adapted to display said identifier over a first temperature range.

19. The display medium of claim 18, wherein said image provides a first information regarding a product to which it is attached, and said at least one identifier provides a second information regarding the product to which it is attached.

20. The display medium of claim 18, further comprising:
a second identifier formed in a temperature sensitive material, said second identifier adapted to be displayed over a second temperature range, and
wherein said second identifier provides a third information regarding the product to which it is attached.

21. An image reader comprising:
an integrated reader unit for reading at least one image providing a first information about a particular product to which said at least one image is attached, wherein said at least one image is associated with at least one identifier formed in a temperature sensitive material, wherein said identifier is adapted to be displayed over a first temperature range, said at least one identifier providing a second information about said product;
said reader unit reads said identifier when displayed;
a reference unit for referencing said first information or said first and said second information dependent upon whether said at least one image or said at least one image and said at least one identifier is read by the reader unit; and
a decision device for taking an appropriate action.

22. The image reader of claim 21, wherein said decision device for taking an appropriate action comprises an alarm device for invoking a warning alarm.

23. A method for creating a display medium comprising the steps of:
providing at least two temperature sensitive zones within said display medium, a first zone being adapted to display a first image within a first temperature range, and a second zone being adapted to display a second image within a second temperature range, wherein each image provides information about a product to which the display medium is attached.

24. A method for creating a display medium comprising the steps of:
providing at least one image; and
forming at least one identifier in a temperature sensitive material, said at least one identifier being adapted to be displayed over a first temperature range.

25. The method of claim 24, further comprising a second identifier, said second identifier being formed in a temperature sensitive material adapted to be displayed over a second temperature range.

26. A system comprising an integrated image reader for reading one of at least two images attached to a product and formed in a temperature sensitive material, a first image adapted to be displayed over a first temperature range, and a second image adapted to be displayed over a second temperature range, said system comprising:
a reading unit for reading a displayed image;
a storage device for storing a first information relating to said first image;
said storage device further stores second information relating to said second image;
an access unit for accessing one of said first information and said second information dependent upon whether said first or said second image is read by integrated image reader; and
an action taking unit for taking an appropriate action based on the information accessed.

27. The system of claim 26, further comprising a cooking apparatus, wherein said appropriate action comprises programming said cooking apparatus with stored parameters.

28. The system of claim 27, wherein said stored parameters comprise a cooking time and a heat setting.

29. The system of claim 26, wherein said first information and said second information relates to stock level of the product to which said at least two images are attached.

30. The system of claim 29, wherein one of said at least two images refers to a damaged product.

31. The system of claim 29, wherein said action taking unit comprises a controller for invoking an alarm when one of said at least two images is read by said image reader.

32. The system of claim 26, further comprising a refrigeration apparatus, wherein said appropriate action comprises, responsive to said first image being displayed, sounding an alarm to indicate that the product to which said first image is attached should not be placed therein.

33. The system of claim 26, further comprising a freezing apparatus, wherein said appropriate action comprises, responsive to said first image being displayed, lowering the temperature within at least a part of said apparatus for a predetermined amount of time.

34. A system comprising an integrated image reader for reading at least one image attached to a product, wherein said at least one image is associated with at least one identifier, said at least one identifier being formed in a temperature sensitive material adapted to display said at least one identifier over a first temperature range, said system comprising:
an integrated image reader for reading said at least one image;
said reader is used for reading said at least one identifier when displayed;
a storage device for storing a first information relating to said at least one image;
a storage device for storing a second information relating to said at least one identifier;
an access unit for accessing one of said first information or said first information and said second information dependent upon whether said at least one image or said at least one image and said at least one identifier is read by integrated image reader; and
an action taking unit for taking an appropriate action based on said information accessed.

35. The system of claim 34 further comprising:
a second identifier associated with said at least one image and formed in a temperature sensitive material adapted to be displayed over a second temperature range;
said reader for reading said second identifier when displayed; a storage device for storing a third information relating to said second identifier;
said access unit is used for accessing said third information when said first image and said associated second identifier is read.
